(19) United States
(12) Patent Application Publication
(10) Pub. No.: US 2013/0282625 A1
(43) Pub. Date: Oct. 24, 2013

(54) METHOD OF FOOD ADVERTISING

(71) Applicant: Yi-Che CHIU, Tainan City (TW)

(72) Inventor: Yi-Che CHIU, Tainan City (TW)

(21) Appl. No.: 13/523,652

(22) Filed: Jun. 14, 2012

(30) Foreign Application Priority Data
Apr. 20, 2012 (TW) 101114079

(51) Int. Cl. G06Q 90/00

(52) U.S. Cl. 705/500

(57) ABSTRACT

The present invention provides a method of food advertising which includes the following steps of: to form a vender marking region, at least one third-party marking region and a merchandise name marking region on the packaging material; a food vendor marks food information of the food in the vender marking region and marks merchandise name of the food in the merchandise name marking region; at least one third-party company pays the food vendor a certain amount of fee to obtain the right of using the third-party marking region; and the third-party company marks an advertisement content in the third-party marking region. Whereby, the payment paid by the third-party company can serve as a subsidy of the cost of the packaging material, so that consumers can purchase the food with lower expense or for free.

### BACKGROUND OF THE INVENTION

1. Field of the Invention

The present invention relates to a method of food advertising.

2. Description of the Prior Art

Recently, food manufacturers buy raw materials to manufacture food products that are available to the public, and mark symbols such as a trademark on the products for the advertisement purposes. Consumers have to pay money to purchase the food. Hence, it is considered natural that companies focus on the development of food and consumers pay money to purchase the food, so this regular rule goes year by year.

However, the above conventional method of food advertising is carried out with symbols such as a trademark marked on the packaging material. The costs of designing and printing the advertisement are usually added to the food products, and it becomes the burden of the consumers to purchase the food products, and this decreases the competitiveness of the food products.

In addition, the above conventional method of food advertising cannot bring more benefits of advertisement. The advertisement has to be applied onto the packaging material; otherwise the food products will be monotonous and unattractive. For food manufacturers, it is hard to decide whether to mark the advertisement onto the packaging material or not.

Besides, for the above conventional method of food advertising, the content of the advertisement has to be renewed for every period of time, to provide freshness to the consumers. However, every renewal of the advertisement content requires a newly design and an additional expense therefore, and thus it is uneconomic.

The present invention is, therefore, arisen to obviate or at least mitigate the above mentioned disadvantages.

### SUMMARY OF THE INVENTION

The main object of the present invention is to provide a method of food advertising which is adapted for a third-party company to obtain the right of using the advertisement on the packaging material, and for consumers to purchase the food with lower expense or even for free.

To achieve the above and other objects, a method of food advertising of the present invention is adapted for applying to a packaging material, wherein the packaging material is adapted for containing a food, and the method includes the steps of:

step 1: to form a vender marking region, at least one third-party marking region and a merchandise name marking region on the packaging material;

step 2: a food vendor marks food information of the food in the vender marking region and marks merchandise name of the food in the merchandise name marking region;

step 3: at least one third-party company pays the food vendor a certain amount of fee to obtain the right of using the third-party marking region; and

step 4: the third-party company marks an advertisement content in the third-party marking region.

The right of the use which the third-party company obtains is limited to be used in at least one certain kind of food for a specific term, and then diverted to be used in another kind of food.

The method of food advertising of the present invention is provided for the third-party company to mark an advertisement content in the third-party marking region on the packaging material. The food vendor can make a reduction of the price of the food base on the payment paid by the third-party company, so that consumers can purchase the food with lower expense or for free.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a flow chart of the present invention;

FIG. 2 is a drawing showing the present invention applied to a plastic packaging sheet; and

FIG. 3 is a drawing showing the present invention applied to a bottle.

### DETAILED DESCRIPTION OF THE PREFERRED EMBODIMENTS

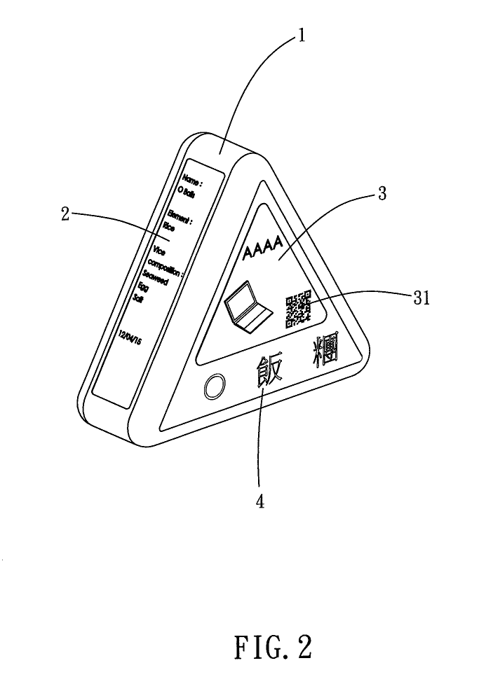

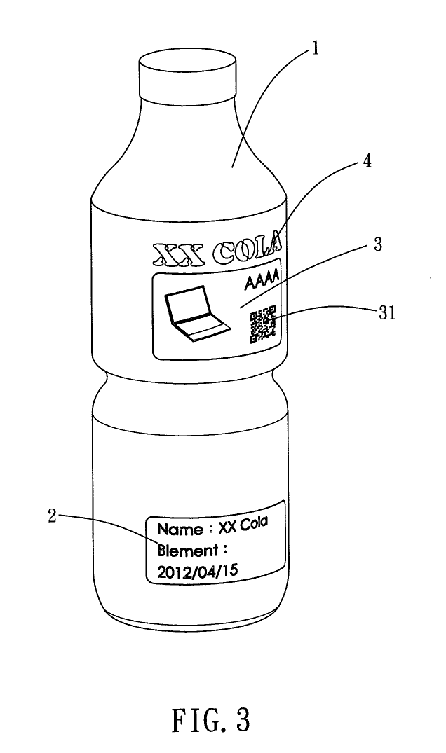

As shown in FIGS. 2 and 3, the method of food advertising is adapted for being applied to a packaging material 1 for containing a food. The kind of the packaging material 1 may very according to various kind of food, such as rice balls, bread, a hamburger and a sandwich, that has a certain shape and should be kept in fresh, in which the packaging material 1 is usually a plastic packaging sheet (as shown in FIG. 2) or a packaging paper. For liquid food such as beverages, the packaging material 1 is usually a bottle (as shown in FIG. 3), tetra pack (or retort pouch) or paper box, etc.

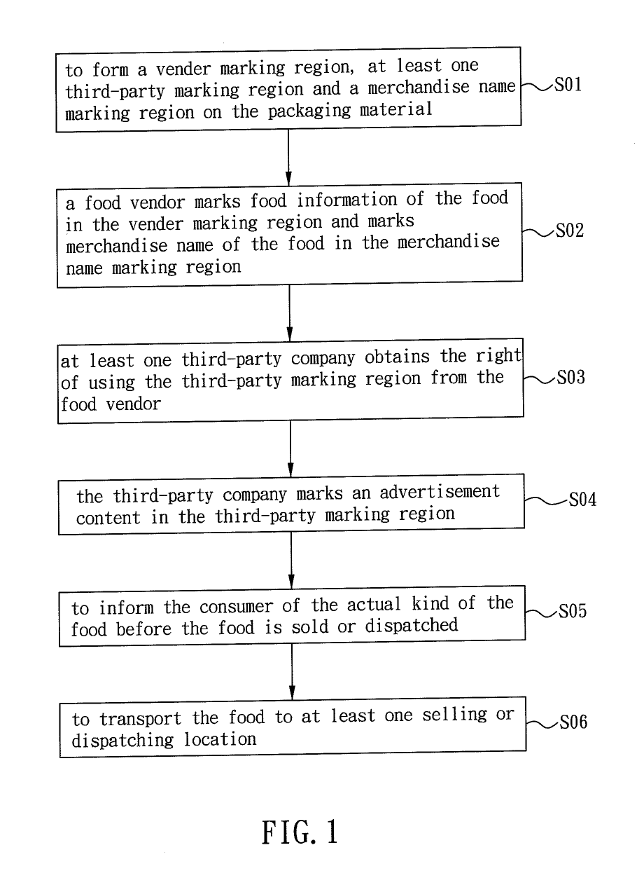

As shown in FIGS. 1 to 3, the method of food advertising includes the following steps.

Step 1 (S01): to form a vender marking region 2, at least one third-party marking region 3 and a merchandise name marking region 4 on the packaging material 1.

Step 2 (S02): a food vendor marks food information of the food in the vender marking region 2, wherein the food information may be about the content in the packaging material 1, the additives, the expiration data and the food vendor, etc. In addition, the food vendor marks merchandise name of the food in the merchandise name marking region 4, for consumers to obtain the food information.

Step 3 (S03): a third-party company which is different from the food vendor obtains the right of using the third-party marking region 3 from the food vendor. In this embodiment, the third-party company pays the food vendor a certain amount of fee to obtain the right of using the third-party marking region 3. In other embodiments, the third-party company may obtain the right of using the third-party marking region 3 in other ways. In this embodiment, the food vendor makes a reduction of the price of the food, and the price reduction is equal to the expense of a single piece of the merchandise. For example, as the marked price of the food is 25 dollars and the third-party company pays the food vendor 3 dollars for a single piece of the merchandise to obtain the right of using the third-party marking region 3, the food vendor will make a “3 dollars” reduction of the price of the food, that is, the actually sold price of the food, lower than the marked price of 25 dollars, is 22 dollars, so that consumers can purchase the food with lower expense. Similarly, as the third-party company pays the food vendor 25 dollars for a single piece of the merchandise to obtain the right of using the third-party marking region 3, the food vendor will make a “25 dollars” reduction of the price of the food, that is, the actually sold price of the food is “0 dollar”, so that consumers can purchase the food for free.

In other embodiments, the packaging material 1 may be formed with a plurality of third-party marking regions for various companies to obtain the right of using the respective third-party marking regions from the food vendor.

Step 4 (S04): the third-party company marks an advertisement content in the third-party marking region 3. The advertisement content includes at least one pattern, text, or any combination thereof, such as the photo of the food, symbols or the trademark of the third-party company. The advertisement content may further includes at least a two-dimensional barcode 31, the two-dimensional barcode 31 is preferably a QR code, adapted for being read by a media device and communicated with a server. The media device may be a device such as a smart mobile phone or a tablet PC. The third-party company may build up a website in the server, and publish the information of activities or trivia games (answer questions for prizes) on the website. The information of activities or trivia games is preferably related to the food. For example, consumers can collect several of third-party marking regions 3 and purchase the food for free or a discount. More important, the server includes an analyzing unit with analyzing software loaded therein. The analyzing unit can count the amount of the consumer's logins into the website and analyze how effectively popularized the advertisement actually is by utilizing the analyzing software, so as to let the third-party company rapidly realize effects of the advertisement. The third-party company can inform the food vendor of the analysis result, so that the food vendor can recognize the suitable kind of third-party marking region 3 for a certain third-party company, so as to improve effects of the advertisement.

Step 5: before the food is sold or dispatched, the food vendor informs the consumer of the actual kind of the food, where the food is sold or dispatched for free, through television advertising, Internet, or flyers.

Step 6: to transport the food to at least one selling or dispatching location.

Given the above, in the method of food advertising of the present invention, the necessary merchandise name of the food and the food information are reserved on the packaging material 1, and one or several of the third-party marking regions 3 are further provided for the third-party companies to use. The third-party company pays the food vendor a certain amount of fee to obtain the right of using the third-party marking region 3, and the food vendor will make a reduction of the price of the food, so that consumers can purchase the food with lower expense or for free.

In addition, the two-dimensional barcode 31 and the server with the analyzing software can help the third-party companies to know how effectively popularized the advertisement actually is, without the selling information provided by the food vendor. Besides, more advertisements or information of activities can be published on the website, for consumers to access them through using the media device to read the two-dimensional barcode 31.

It should be noted that in this embodiment, the right of the use which the third-party company obtains is limited to be used in at least one certain kind of food for a specific term, and the third-party marking region 3 on the packaging material 1 is transferred to another third-party company after the specific term expired. By this way, the third-party marking region 3 on the packaging material 1 can be provided for various third-party companies to use regularly, so as to renew advertisement content in the third-party marking region 3. Each of the renewed advertisement content is not much similar to one another, and thus it will be novel and consumers will look forward to the next renewed advertisement content. As to the original right of using the third-party marking region 3, it is then diverted to be used in a packaging material 1 of another kind of food after the specific term expired, and this allows the third-party company to transfer the advertisement content to packaging materials 1 of various kinds of foods constantly, so that the cost of the advertisement can bring preferable benefits.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A method of food advertising applied to a packaging material, the packaging material adapted for containing a food, the method including the steps of:
step 1: to form a vender marking region, at least one third-party marking region and a merchandise name marking region on the packaging material;
step 2: a food vendor marks food information of the food in the vender marking region and marks merchandise name of the food in the merchandise name marking region;
step 3: at least one third-party company pays the food vendor a certain amount of fee to obtain the right of using the third-party marking region; and
step 4: the third-party company marks an advertisement content in the third-party marking region.

2. The method of food advertising of claim 1, further including step 5: to inform the consumer of the actual kind of the food before the food is sold or dispatched.

3. The method of food advertising of claim 2, further including step 6: to transport the food to at least one selling or dispatching location.

4. The method of food advertising of claim 1, wherein the right of the use which the third-party company obtains is limited to be used in at least one certain kind of food for a specific term, and then diverted to be used in another kind of food after the specific term expired.

5. The method of food advertising of claim 1, wherein as the third-party company pays the food vendor the certain amount of fee to obtain the right of the using the third-party marking region, the food vendor makes a reduction of the price of the food, so that consumers can purchase the food with lower expense or for free.

6. The method of food advertising of claim 1, wherein the advertisement content includes at least one pattern, text, or any combination thereof.

7. The method of food advertising of claim 6, wherein the advertisement content further includes at least a two-dimensional barcode, and the two-dimensional barcode is adapted for being read by a media device and communicated with a server.

8. The method of food advertising of claim 7, wherein the server includes an analyzing unit.
